(19) United States
(12) Patent Application Publication
(10) Pub. No.: US 2026/0274529 A1
(43) Pub. Date: Sep. 17, 2026

(54) CONTAINER LID WITH SCALE

(71) Applicant: SYNDICATE ENTERPRISES, LLC, Plano, TX (US)

(72) Inventor: Iftach Scharf, Amsterdam (NL)

(73) Assignee: SYNDICATE ENTERPRISES, LLC, Plano, TX (US)

(21) Appl. No.: 19/080,547

(22) Filed: Mar. 14, 2025

(51) Int. Cl. B65D 51/24; A47J 47/06; B65D 51/18; B65D 51/30; B65D 53/02; B67C 11/02; G01G 19/52

(52) U.S. Cl. CPC B65D 51/245; A47J 47/06; B65D 51/18; B65D 51/30; B65D 53/02; B67C 11/02; G01G 19/52; B65D 2251/0021; B65D 2251/0081

(57) ABSTRACT

A storage container for spices, herbs and other consumables has a removable airtight lid with a built-in digital scale on top and a recessed storage compartment on the bottom to hold a humidity stabilizer which controls the humidity inside the container to help preserve the material stored in the container. A protective cover in the form of a flip top lid covers and protects the digital scale. A weighing tray is removably stored inside the protective cover where it is detachably secured by a pair of arms or by magnets. The tray can be selectively detached from the cover and placed on the scale to hold the material being weighed. The tray has a handle and a funnel for dispensing material from the tray in a controlled manner.

### BACKGROUND

This invention relates generally to storage containers, and more particularly has reference to a multi-functional lid for a storage container specifically designed for storing, weighing and dispensing spices and other herbs in a manner that will prolong usability and facilitate ease of use.

Storage containers for spices and herbs are well known. Scales for weighing spices and other herbs are also known.

However, a problem exists in the art, in that each of those functions typically requires a separate device. The material to be weighed must first be removed from its packaging or storage container with a spoon or the like, then placed on a scale for weighing. Each of those devices takes up counter space and requires separate storage. When the weighing is completed, the material to be used must then be transferred from the scale to a point of usage, while the excess or leftover material is removed from the scale and put back into the storage container. The storage container, the spoon and the scale must then be returned to separate storage locations, where they can get lost or be misplaced, hampering further use. Also, material that is left in storage for too long may become stale or moldy, alternatively, may desiccate and loose its taste or aroma.

There is a need in the art for an improved system for the managing and storing of fresh herbs, spices and other products over long periods of time and for facilitating the weighing and handling of such materials. The present invention addresses these and other needs.

### SUMMARY OF THE INVENTION

Briefly, and in general terms, the present invention relates to a new and improved lid for a storage container designed for storing spices and herbs, that is multi-functional and has a variety of features for dispensing, weighing and preserving material stored in the container with a single compact and integrated product where everything needed is organized and stored in one place.

In some embodiments, the invention is directed to a removable lid with a built-in digital scale for weighing material removed from the container and displaying the results on a visual display screen located alongside the weighing platform on the top of the lid. The digital scale may also include controls disposed on the top of the lid near the visual display for facilitating ease of use.

In some embodiments, the lid includes a sealing ring surrounding a lower portion of the lid to provide an airtight seal when storing the aforementioned materials inside a jar or container.

In some embodiments, a protective cover is provided to selectively cover and protect the digital scale mounted on the top of the lid. A hinge allows the cover to be selectively opened and closed like a flip top lid.

In some embodiments, a weighing tray is removably attached and stored inside the protective cover. The weighing tray may be detachably secured inside a cavity by a pair of latching arms that grip the tray and hold it in place inside the cover.

In some embodiments, the weighing tray is detachably secured inside the protective cover by magnets.

In some embodiments, the weighing tray may be provided with a sloping ramp for facilitating the dispensing of stored material from the tray.

Insome embodiments, a recessed storage compartment is provided on the bottom of the lid for removably holding a small humidity stabilizer, which acts to prolong the freshness and quality of material stored in the container.

In some embodiments, a removable access cover is provided to cover the recessed storage compartment and hold the humidity stabilizer inside the compartment. The access cover may be provided with one or more openings or holes to facilitate airflow through the storage compartment.

In some embodiments, the built-in scale is powered by a rechargeable battery disposed on an elevated platform surrounded by open space inside the lid.

In some embodiments, the structure defining the recessed storage compartment for the humidity stabilizer protrudes inside the lid to provide the elevated platform for the battery.

In some embodiments, a charging port for the battery is provided on an outer surface of the lid.

In some embodiments, the storage system includes a storage container having an opening for accessing an interior chamber of the container, a lid removably attached to the container having an upper portion and a lower portion, the upper portion of the lid having a built-in scale with a weighing platform, display, and controls disposed on a top surface of the lid, and the lower portion of the lid having a size that can fit snugly inside the opening of the container to form an air-tight seal.

In some embodiments, the container lid includes an upper body with a top surface and a first sidewall extending down from the top surface, the sidewall having outer dimensions, a built-in scale mounted in the upper body, the scale including a weighing platform, a display and controls disposed on the top surface of the upper body, and a lower body with a bottom surface and second sidewall extending up from the bottom surface, the second sidewall having relatively smaller outer dimensions than the first sidewall and being surrounded by a seal ring adapted to fit snugly inside a container opening to provide an air-tight seal.

In some embodiments, the container lid includes an upper body having a top surface and a sidewall extending down from the top surface, a lower body adapted to selectively engage with and close a container opening for accessing an interior chamber of a storage container, a built-in scale mounted in the upper body with a weighing platform, a display and controls disposed on the top surface of the upper body, and a protective cover for the top surface of the upper body adapted to selectively cover and protect one or more of the weighing platform, display and controls.

These and other features and advantages of the invention will become more apparent from the following detailed description, considered in conjunction with the accompanying drawings, which illustrate by way of example, features of the invention.

### BRIEF DESCRIPTION OF THE DRAWINGS

FIG. 1 is a perspective view of a storage system incorporating features of the present invention;

FIG. 2 is a perspective view of the system shown in the FIG. 1 with the lid removed;

FIG. 3 is an exploded perspective view of the lid shown in FIG. 2;

FIG. 4 is a partially exploded perspective view of the lid shown in FIG. 3 without the weighing tray;

FIG. 5 is an enlarged perspective view of the lid shown in FIG. 4, partially assembled, and without the protective cover;

FIG. 6 is an enlarged perspective view of the lid shown in FIG. 2 with the protective cover closed;

FIG. 7 is a perspective view of the lid shown in FIG. 6 with the protective cover open to expose the built-in scale;

FIG. 8 is an enlarged perspective view of the storage system shown in FIG. 1 with the protective cover open to expose the built-in scale and showing the weighing tray in use on the weighing platform;

FIG. 9 is a top plan view of the storage system shown in FIG. 8 showing material in the weighing tray;

FIG. 10 is an enlarged perspective view of the removable lid shown in FIG. 2 as seen from below;

FIG. 11 is a perspective view of the removable lid shown in FIG. 10 with the access cover removed to expose the interior of the humidifier storage compartment;

FIG. 12 is an enlarged side elevational view, partially in section, of the storage system shown in FIG. 1 showing material inside the storage container;

FIG. 13 is an enlarged side elevational view of the storage system shown in FIG. 1 as seen from the rear showing the hinge for the protective cover and the battery charging port,

FIG. 14 is a fragmentary perspective view of an alternative embodiment of the lid shown in FIG. 7, with the weighing tray removed from the lid and as seen from below; and

FIG. 15 is a fragmentary perspective view of the lid shown in FIG. 14, with the weighing tray stored inside the cover.

### DETAILED DESCRIPTION OF THE PREFERRED EMBODIMENTS

In the following detailed description, certain preferred embodiments are described which include various features of the present invention.

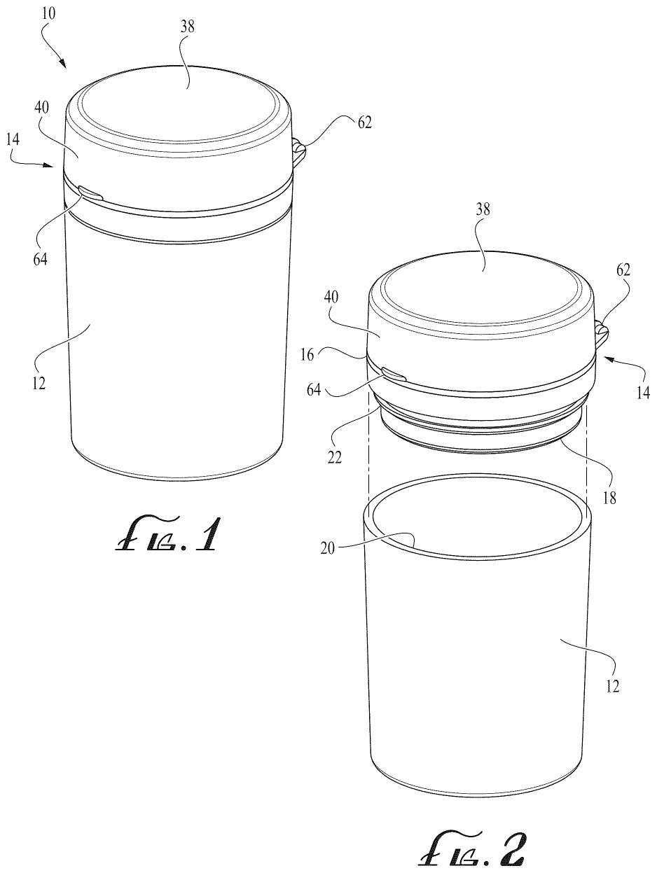

FIG. 1 shows a first embodiment of the invention, a storage system 10 for herbs and the like, which takes the form of a storage container 12 with a removable lid 14, each preferably possessing, at least in part, the same outer cylindrical profile. While the preferred shape is cylindrical, it will be appreciated by those of ordinary skill in the art, that other shapes are possible.

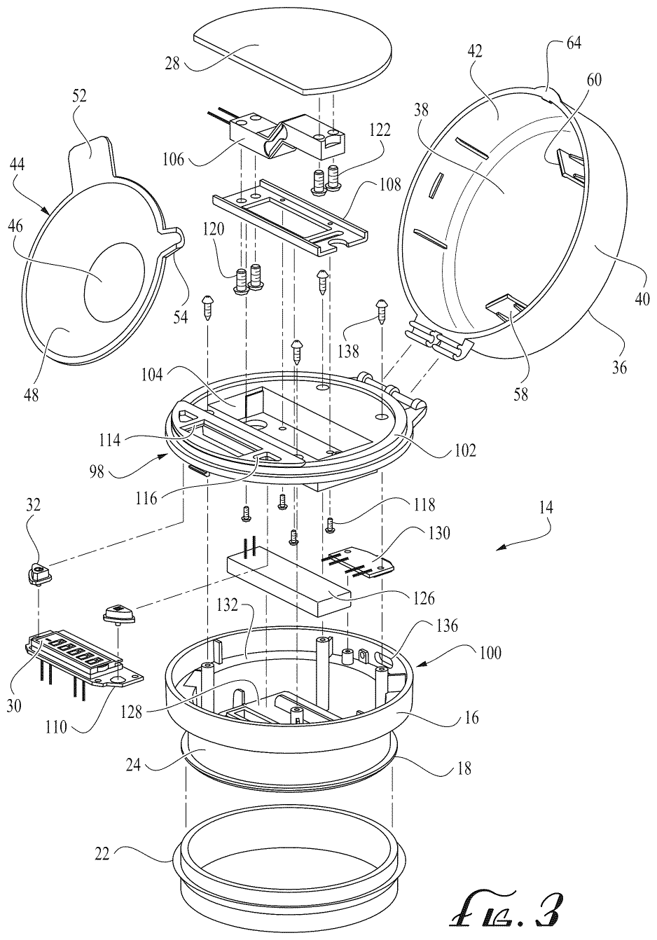

The storage container 12 is preferably a wide-mouthed jar or similar vessel (as best shown in FIG. 2), made of glass, metal, plastic or another material, and typically having an interior chamber, used for storing a supply of spices, herbs or other consumables in a manner that will prolong their freshness or usability, and preferably having a removable air tight lid 14. Preferably, the lid 14 seals the storage container 12 in such a manner as to eliminate or reduce the amount of oxygen, heat, light and moisture that come in contact with any products stored in the container.

As best shown in FIG. 2, the removable lid 14 has an upper portion 16 with relatively larger outer dimensions matching the outer dimensions of the storage container 12, and a lower portion 18 having slightly smaller dimensions matching the inner dimensions of the storage container. This allows the lower portion 18 of the lid 14 to be inserted snugly into the open top end 20 of the storage container 12, leaving the upper portion 16 of the lid 14 exposed above the storage container. The container 12 will typically be about 2″ to 4″ in diameter, but can be larger for commercial uses with different shapes such as rectangular or square. Typical dimensions for the lid 14 when used with cylindrical jar or container include an upper portion 16 with an outer diameter of about 3¼″, a lower portion 18 with an outer diameter of about 2¾″, and a height of about 1⅛″, although other sizes are possible.

Arranged to surround the lower portion 18 of the lid 14 is a flexible silicone or rubber sealing ring 22 which may be seated in an annular grove 24 formed in the lower portion of the lid, as best shown in FIG. 3. When the lower portion 18 of the lid 14 is inserted into the open end 20 of the storage container 12 with pressure, the sealing ring 22 compresses against the interior surface of the container to form an air-tight seal that protects whatever contents are in the container. The lid 14 typically requires some pressure to fully close and ensure a proper seal. The lid 14 is preferably made of glass, metal, plastic or another material, and preferably matches the material used for the container 12. Making the container out of stainless steel or hard molded plastic has the advantage of being rugged yet easy to clean.

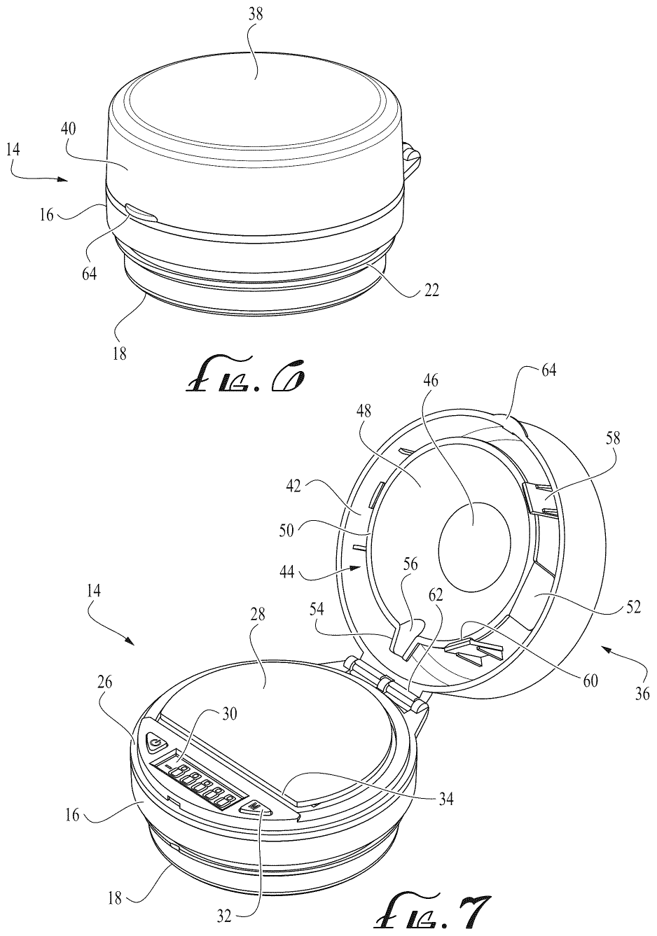

As best shown in FIG. 7, the lid 14 preferably includes a built-in scale with a weighing platform 28, a visual display 30, and controls in the form of buttons or keys 32 disposed on the top 26 of the lid. The scale can be analog or digital, but is preferably digital with a digital display 30 for displaying the information obtained by the digital scale. The display preferably has large numbers and is backlit so that is easy to read. In a preferred embodiment, the weighing platform 28 is made of stainless steel and occupies only a portion of the top surface 26, leaving enough room on the surface for the display screen 30 and controls 32 to be placed adjacent the weighing platform for ease of visibility and use.

In a preferred embodiment, the lid 14 is cylindrical in shape, and the weighing platform 28 preferably has a semi-circular shape with a major arc of slightly greater than 180 degrees, terminating in a straight edge 34 with the display screen 30 and control buttons 32 being disposed on the surface 26 along the straight edge, as best shown in FIG. 7.

Digital scales are well-known and work by using electrical sensors, typically called load cells, to convert the force exerted by an object's weight into an electrical signal, which is then processed and displayed as a digital weight reading on a display screen. Essentially, the load cell measures weight by bending slightly when pressure is applied to a weighing platform that rests on top of the load cell. The bending causes a change in electrical resistance which is measured and converted into a digital value by an electrical circuit. Most digital scales are capable of accurately measuring small amounts such as ⅛ ounce or 1 gram.

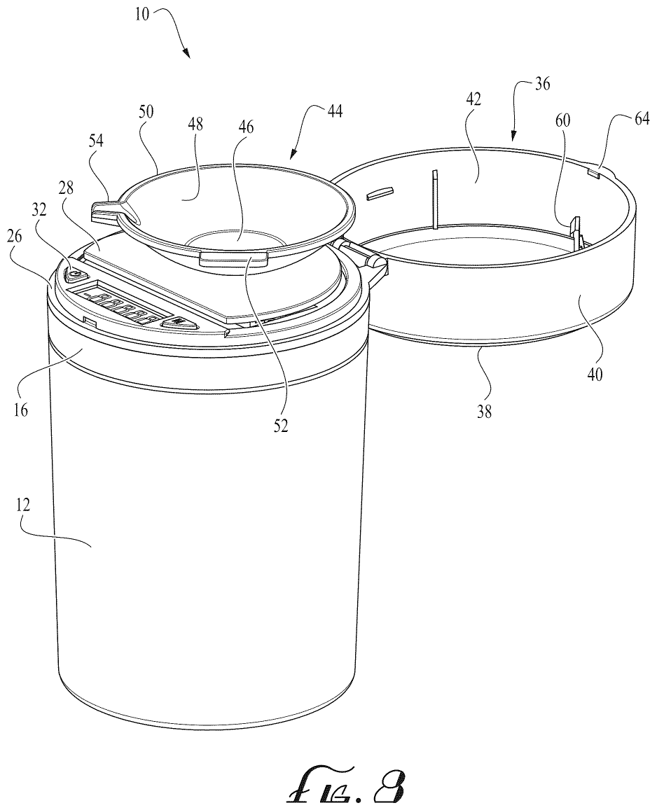

As best shown in FIGS. 6 and 7, a protective cover or cap 36 is provided to cover and protect some or all the digital scale components 28, 30, 32 when the scale is not in use and for aesthetics. The cover 36 preferably includes a flat top surface 38 with a sidewall 40 extending down from the top surface to define an interior cavity 42 for detachably storing a weighing tray 44 used to hold material being weighed on the scale. Various types of weighing trays 44 can be used, including the tray shown in FIGS. 7 and 8, which is preferably concave in shape with a flattened floor 46, a sidewall 48 and a circular opening 50 at the upper end of the sidewall, a small handle 52 extending radially outward from the upper end of the sidewall for holding the tray when in use, and a short funnel 54 extending radially outward from the upper end of the sidewall at right angles to the handle and spaced 90 degrees away from the handle. The funnel 54 forms a sloping channel or ramp 56 (FIG. 7) which extends into the interior of the tray 44 toward the floor 46 for conveying and dispensing material from the tray back into the container or into another place for intended use. By holding the tray 44 with the handle 52 and tilting the tray to the side, any herbs or other material contained in the tray may be directed into the funnel 54 and thence with further tilting, caused to pass along the funnel and leave the tray in a user-control manner.

There are a number of advantages that come from providing the weighing tray 44. In addition to holding and confining the material to be weighed on the scale, the tray 44 can also be used as a small mixing bowl or storage bowl for temporary storage of material removed from the container 12. This allows the container 12 to be resealed with the lid 14 while materials removed from container 12 and placed into the tray 44 are being weighed or are otherwise being dispersed to the place of intended use. Proving a dedicated weighing tray 44 associated with one particular lid 14 also minimizes the risk of cross-contamination that could occur if one tray was used with multiple containers containing different materials.

When not in use, the weighing tray 44 is preferably secured inside the protective cover 36 by a pair of latches in the form of arms 58 with barbed ends or claws 60 that extend downward from the top 38 of the cover 36 at spaced locations inside the cavity 42, as best shown in FIG. 7. The arms 58 flex outward to pass over the sidewall 48 of the tray 44 then flex inward to grip the upper end of the sidewall as the tray is moved into a storage position where the bottom of the tray is pressed up against the top 38 of the cover 36.

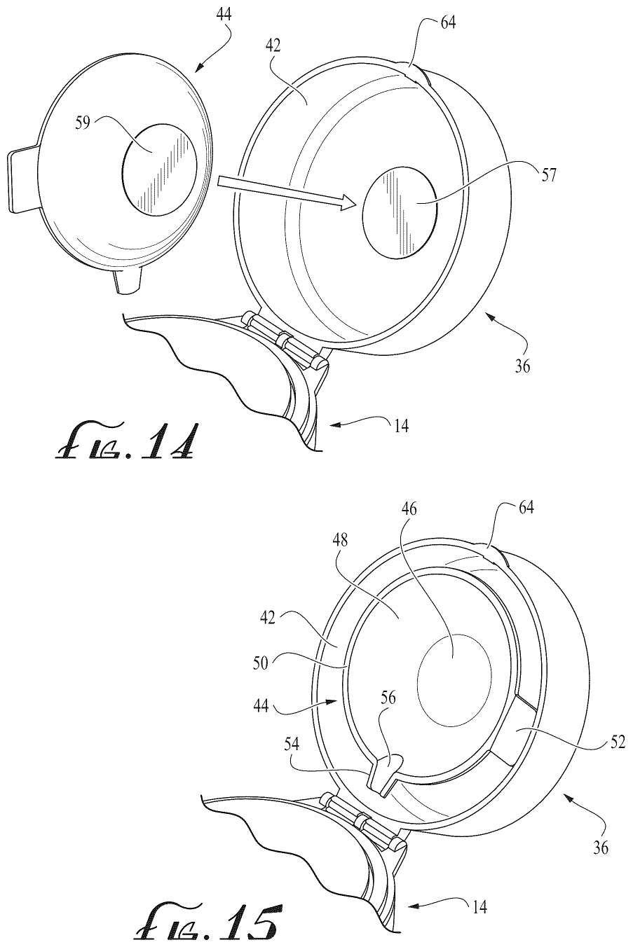

Alternatively, instead of providing the arms 58, the weighing tray 44 can be detachably secured to the protective cover 36 magnetically, as best shown in FIGS. 14 and 15. In this alternative embodiment, a first magnet or ferromagnetic plate 57 is disposed inside the protective cover 36 flush with the flat interior surface at the top 38 of the cover, and a second magnet or ferromagnetic plate 59 is disposed on the flat bottom surface of the tray 44. One or both of the plates 57, 59 can be magnetized. The plates interact with each other magnetically when placed in close proximity to hold the tray 44 in place inside the protective cover 36. If desired, a metal tray 44 can be used instead of the second plate 59, with the first plate 57 being magnetized.

In use, the weighing tray 44 is first removed from the cover 36 by opening the cover and pulling upward on the handle 52 to free the tray 44 from engagement with the arms 58 or magnets 57, 59, then placed on the weighing platform 28 as shown in FIG. 8, with the opening 50 facing up so that material to be weighed can be removed from the storage container 12 and collected in the measuring tray, which acts as a temporary storage bowl for holding the material to be weighed. If desired, the tray 44 also can be used to scoop out from the storage container 12 the material to be weighed. When the weighing is completed, the tray 44 can be emptied, wiped clean and returned to its storage location within the protective cover 36 as previously described.

In a preferred embodiment, the protective cover 36 is in the form of a flip top lid which is cylindrical in shape to match the diameter and contours of the upper portion 18 of the removable lid 14 for aesthetic purposes. To this end, both the protective cover 36 and the removable lid 14 are preferably made of the same material. The protective cover 36 is preferably attached to the lid 14 by a hinge 62 disposed on the lower edge of the cover 36 as shown in FIG. 7. The hinge 62 allows the cover 36 to be flipped open and flipped closed by the user as desired. A small finger grip 64 is provided on the lower edge of the cap 36 diametrically opposite of the hinge 62 as shown in FIG. 7, to allow the user to place a finger under the grip and flip open the cover via the hinge. This gives free access to the digital scale and to the weighing tray 44 mounted inside the protective cover 36.

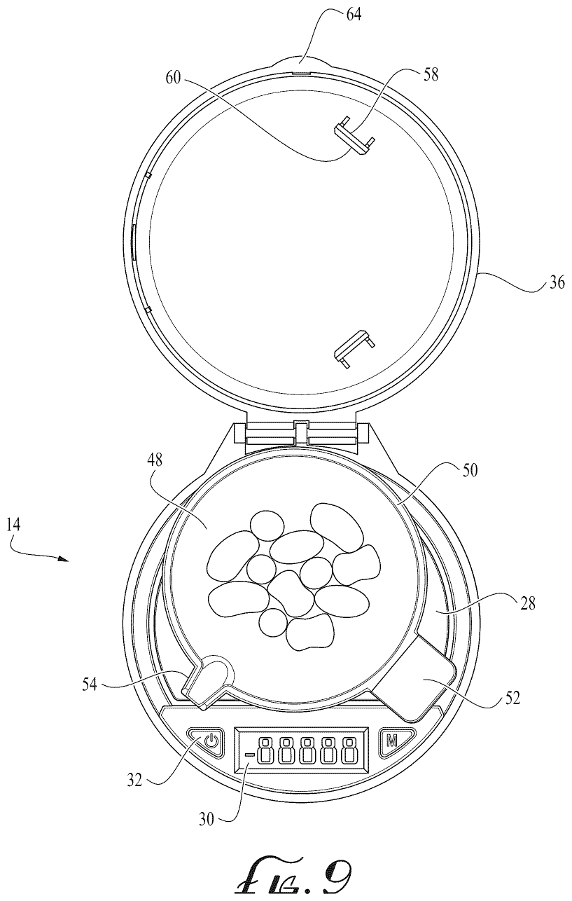

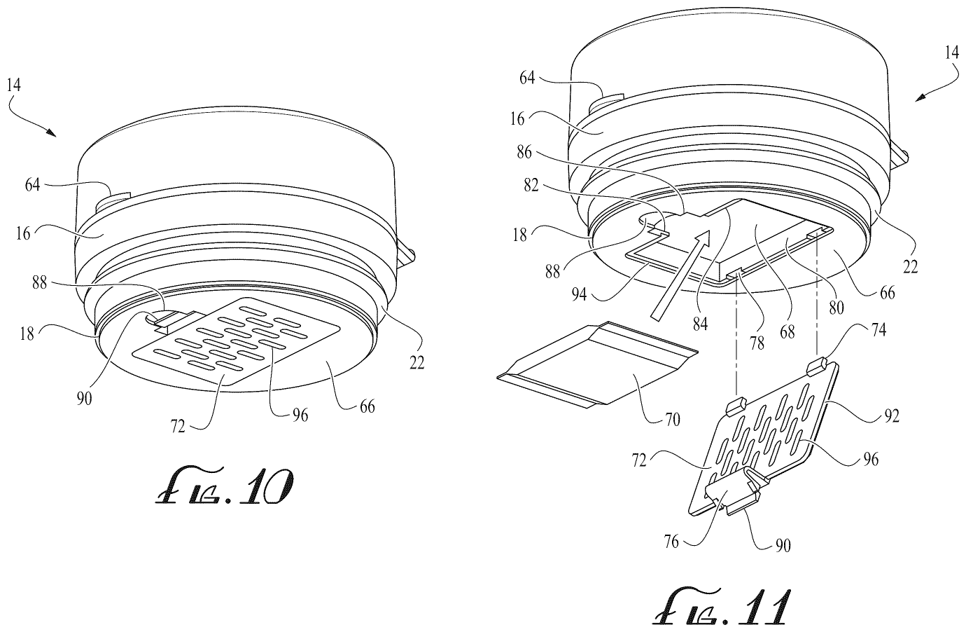

In another aspect of the invention, as best understood with reference to FIGS. 10 and 11, a bottom surface 66 of the removable lid 14 includes a recessed compartment 68 which is sized to receive a small amount of humidity stabilizer contained in a small porous bag or sachet 70. An access cover 72, preferably rectangular in shape, is removably attached to the bottom surface 66 of the lid 14 to close the humidifier compartment 68 and protect the humidifier bag 70 placed within. A latching mechanism is used to detachably engage the access cover 72 with the bottom surface 66 of the lid 14. The latching mechanism can include a pair of hooks or tabs 74 at one end of the cover 72 and a resilient locking pin 76 protruding perpendicularly from the other end of the cover. A pair of openings or grooves 78 are formed on the backside wall 80 of the humidifier compartment 68 and a locking hole 82 is provided in the bottom surface 66 of the lid 14 near the frontside wall 84 of the humidifier compartment. In assembly, the hooks or tabs 74 are first inserted into the grooves 78 in the backside wall 80 of the compartment 68, then the access cover 72 is pressed downwardly toward the bottom surface 66 of the lid 14 until the locking pin 76 is inserted into the locking hole 82, whereupon the resilient locking pin is compressed by the wall 86 adjacent the locking hole until the locking pin reaches a second position where the resilient element decompresses and engages the underside of the wall 86 adjacent the locking hole to secure the locking pin 76 and cover 72 in place. An outward notch or depression 88 is formed along a short length of the bottom surface 66 near the locking hole 82 to form an area suitably large for user to insert a finger tip into the notch and snag the end of a flange 90 protruding laterally from the end of the locking pin 76 to compress the resilient element, release the locking pin from the locking hole, and remove the cover 72 to give free access to the humidifier compartment 68. In a preferred embodiment, the outer edge 92 of the access cover 72 fits into an annular recess 94 formed around the humidifier compartment 68 in the bottom surface 66 of the lid 14 so that the cover when in place is flush with the bottom surface of the lid as shown in FIG. 10.

In a preferred embodiment, a number of small openings or holes 96 are provided in the access cover 72 as best shown in FIG. 10, to allow airflow to/from the humidifier compartment 68, while the access cover holds the humidity stabilizer sachet 70 inside the compartment to prolong the freshness and quality of any herbs or other materials stored in the container 12. The air tight seal provided by the sealing ring 22 facilitates the effectiveness of the stabilizer sachet 70. Various types of stabilizer bags are known and can be used, including for example the Boveda 2-way humidity control, or similar device, which regulates the relative humidity to a pre-set level inside the container 12 by admitting or drawing moisture from the air inside the container to prevent stored herb or other material from accidentally over drying and loosing its aroma, and effect while it cures inside the container.

In a preferred embodiment, the removable lid 14 is constructed in two parts, namely, an upper body 98 and a lower body 100, as best shown in FIGS. 3-5. The weighing platform 28, display screen 30 and control buttons 32 preferably are mounted on the upper body 98. The weighing platform 28 is mounted on the top surface 102 of the upper body 100 over a cavity 104 formed in the upper body to house the load cell 106 and metal support 108 for the load cell. The display screen 30 and control buttons 32 are mounted on a printed circuit board 110 that is attached to an interior surface 112 of the upper body 98 alongside the load cell cavity 104. The printed circuit board 110 is preferably attached to the upper body 98 by screws (not shown) to permit removal of the circuit board 110 in case of any needed repairs or replacement. The printed circuit board 110 includes the main electronic circuitry that is operatively connected to the load cell 106, the display 30 and the control buttons 32 to measure the change in electrical resistance produced by the load cell 106 in response to the weight of material placed on the weighing platform 28, and to processes the resulting electrical signal into a digital weight reading on the display screen 30.

The display screen 30 and control buttons 32 are preferably mounted in such a way that the display screen is visible through a rectangular opening 114 in the upper body 98 while the control buttons 32 project through openings 116 formed in the upper body to the sides of the opening 114 for the display screen. The control buttons 32 may be used to call up and control various functions of the digital scale through the main electric circuity on the circuit board 110, such as for example, the left side button controlling the on/off and reset functions, while the right side button selects the desired measuring units to be displayed on the visual display 30. It will be appreciated by those of ordinary skill in the art that different types of controls including rotary dials and switches can be used instead of buttons or keys to control the functions of the digital scale, if desired.

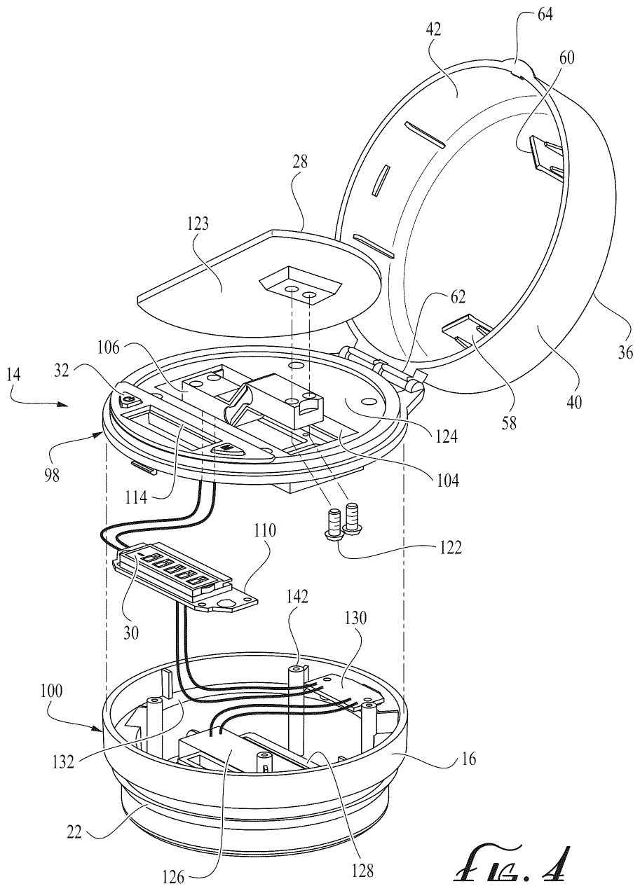

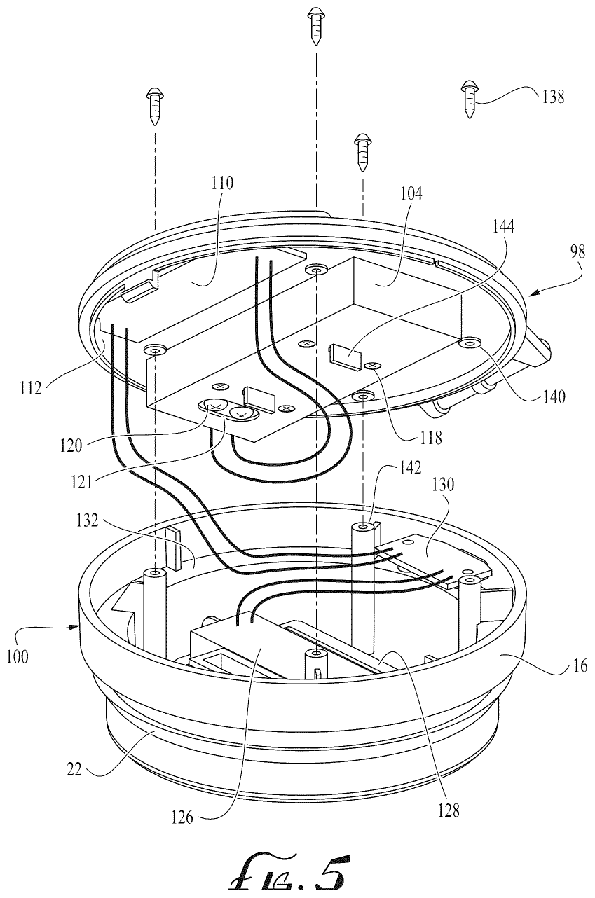

The load cell 106 and metal support 108 are mounted in the cavity 104 formed in the upper body 98, as best shown in FIGS. 3-4. The metal support 108 is preferably attached to the upper body 98 by screws 118 on the underside of the cavity 104, as best shown in FIG. 5. In a preferred embodiment, four screws 118 are used to secure the metal support while two additional screws 120 are used to secure one end of the load cell 106 to the support 108. These load cell screws 120 are preferably accessible through a small opening 121 in the underside of the cavity 104 for ease of access in case of any needed replacement of repair of the load cell 106. The opposite end of the load cell 106 is attached to the underside 123 of the weighing platform 28 by two small screws 122 as best shown in FIG. 4, or by alternative means such as glue or solder. The weighing platform 28 when so attached sits above a recessed area 124 formed in the top surface 102 of the lid 14 around the load cell cavity 104, as best shown in FIG. 4. The weight of any material placed on the weighing platform 28 will cause a downward pressure on the load cell 106 which produces a change in resistance that is sensed by the electronic circuitry on the printed circuit board 110.

In a preferred embodiment, a rechargeable lithium battery 126 is provided as the power source for the digital scale. The battery 126 is preferably mounted on an elevated platform 128 surrounded by open space inside the lower body 100, as best shown in FIGS. 4 and 5. This location allows for safer storage of the battery 126 because it allows for more air to circulate around the battery and for the battery to be spaced away from other parts which could generate heat. It also allows room to provide the humidifier compartment 68 on the bottom surface 66 of the lid 1, in space that otherwise might be occupied by a battery compartment to hold removable external batteries. By using an internal rechargeable battery 126 with the recessed compartment 68 as described above, the elevated platform 128 for the battery 126 can be provided by the backside of the structure defining the recessed compartment 68 which protrudes into the interior of the lower body 100.

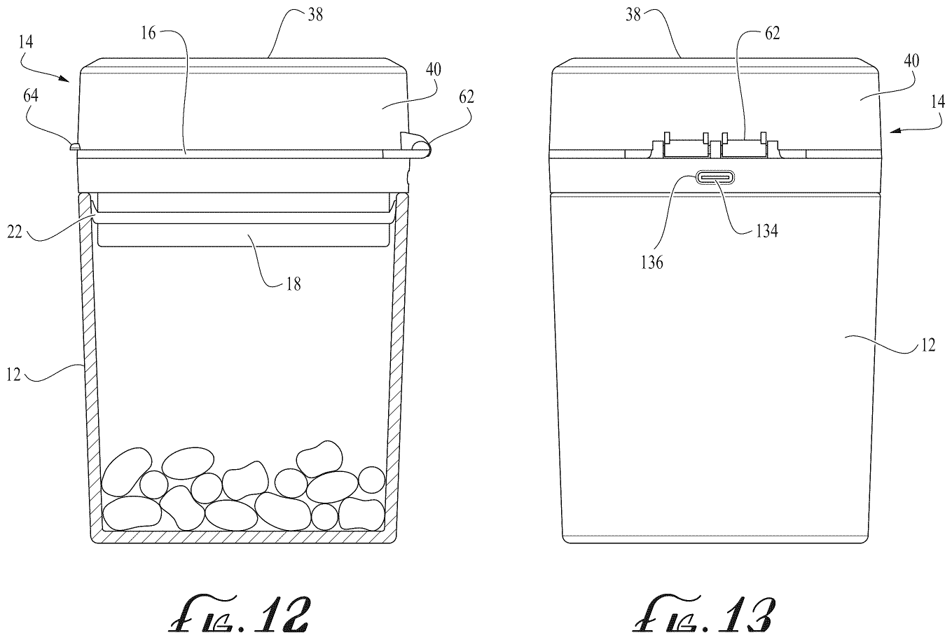

A second printed circuit board 130 including electronic circuitry for charging the battery 126 is mounted on an annular ledge 132 that extends around the interior of the lower body 100 and is operatively connected to the battery 126 and to the main electronic circuitry on the second printed circuit board 110. The ledge 132 joins the upper portion 16 of the lid 14 to the lower portion 18 of the lid. The charging circuit 130 is preferably connected to a USB charging port 134 mounted in an opening 136 on a portion of the lower body 100, as best shown in FIG. 13.

For final assembly, the upper body 98 is placed over the lower body 100, and the two bodies are joined together, preferably by screws 138 that extend through openings 140 in the upper body and are received by threaded hollow posts 142 rising up from the floor of the lower body 100, as best shown in FIG. 5. A pair of spacers 144 extending down from the underside of the load cell cavity 104 abut the top of the battery 126 when the upper and lower bodies 98, 100 are joined together to further hold the battery in place and to keep the battery spaced away from potential heat generating circuitry mounted in the upper body.

One of ordinary skill will appreciate that the foregoing embodiment has multiple functional capabilities by virtue of having a built-in scale, weighing tray, and humidifier in a single device which allows the user to keep stored material fresh and easily accessible while providing a quick and convenient way to weigh such material accurately immediately after taking them out of the container. Once the container 12 is opened by removing the lid 14, some of the material stored inside the container can be taken out and placed in the weighing tray 44 for temporary storage, while the lid is placed back onto the container to preserve the freshness of the material remaining inside the container, and the tray is placed onto the scale for weighing. Placing the lid 14 back on the container 12 for weighing also has the advantage of elevating the weighing platform 28 and other scale components 30, 32 to make them easier to see and use, especially when the lid 14 is relatively small in size. Alternatively, after the container 12 is opened, the lid 14 can be placed on a table or other support surface and the material taken out of the open container and placed into the weighing tray 44 and onto the scale for weighing while the container remains open. This makes it easier to transfer material between the container 12 and the tray 44 as needed. When the weighing is completed, the dispensing funnel on the weighing tray can be used to pour weighed material directly into the point of intended usage. Excess or leftover material can be poured back into the storage container for storage in an ideal temperature and humidity condition by removing the lid from the container and placing the unused material into the container for storage. Securing the air tight lid back into place on the top of the container with the humidity stabilizer in place, will help keep the material fresh inside the container until its eventual use.

The invention has many different uses. For example, it can be used as a kitchen scale to measure ingredients by weight, which is much more accurate than measuring by volume to provide better control over calories and nutrient intake, and ensure a more uniform consistency of recipes. Weighing ingredients is also faster and easier because there is no need to use several different measuring cups or spoons to make sure you have the right amount of each ingredient for a recipe. You only need one tool which doubles as a container lid so it is easy to store away along with the ingredients when not in use.

The invention also can be used by sellers and retailers to accurately dispense spices, herbs and other ingredients that are stored in bulk and sold by weight. This is especially useful for expensive or strong spices and herbs where it is important to keep measurements accurate and reduce waste. Due to its compact design and use as a lid, the device can also save retail counter space for smaller retailers and shops do not have the space for a separate stand-alone scale.

One of ordinary skill in the art will appreciate that the lid of the present invention can be manufactured and sold as a stand-alone device, or as part of a storage system that includes an associated container. Whether sold as a stand-alone device or as part of a complete storage system, the lid is adaptable and can be used with a variety of different containers having an appropriately sized opening.

Although preferred illustrative embodiments of the invention have been illustrated and described above, it will be apparent to those skilled in the art that various changes and modifications may be made thereto without departing from the spirit of the invention. The present embodiments are, therefore, to be considered in all respects as illustrative and not restrictive, while the scope of the invention is set forth in the claims that follow.

I claim:

1. A storage system, comprising:
a storage container having an opening for accessing an interior chamber of the container;
a lid removably attached to the container having an upper portion and a lower portion;
the upper portion of the lid having a built-in scale with a weighing platform, display, and controls disposed on a top surface of the lid;
the lower portion of the lid having a size that can fit snugly inside the opening of the container to form an air-tight seal.

2. The system of claim 1, wherein:
the lower portion of the lid has a bottom surface with a recessed compartment sized to receive a humidity stabilizer, and
an access cover removably attached to the lower portion of the lid to cover the recessed compartment, the access cover being provided with one or more openings to allow airflow through the compartment while the access cover holds a humidity stabilizer inside the compartment.

3. The system of claim 1, wherein a seal ring surrounding the lower portion of the lid provides the air-tight seal between the lid and the storage container.

4. The system of claim 1, further comprising:
a protective cover for the upper portion of the lid to selectively cover and protect one or more of the weighing platform, display and controls.

5. The system of claim 4, wherein the protective cover is a flip top closure attached to the lid by a hinge that allows the protective cover to be selectively flipped open and flipped closed.

6. The system of claim 4, further comprising:
a weighing tray detachably mounted inside a cavity within the protective cover.

7. The system of claim 6, wherein:
the weighing tray has a generally concave shape with a floor, a sidewall and an annular opening at an upper end of the sidewall,
the weighing tray further having a handle extending radially outwardly from the upper end of the sidewall for holding the tray when in use, and a funnel extending radially outwardly from the upper end of the sidewall at right angles to the handle to define a ramp for dispensing material out of the tray when the tray is tilted toward the funnel.

8. The system of claim 6, wherein:
the weighing tray is detachably connected to the protective cover by arms that extend downwardly inside the cavity to grip the weighing tray when the weighing tray is stored inside the cavity.

9. The system of claim 6, wherein:
the weighing tray is detachably connected to the protective cover magnetically when the weighing tray is stored inside the cavity.

10. The system of claim 1, wherein:
the built-in scale is powered by a rechargeable battery resting on an elevated platform surrounded by open space inside the lower portion of the lid.

11. The system of claim 10, wherein:
the lower portion of the lid has a bottom surface with a recessed compartment sized to receive a humidity stabilizer, the recessed compartment being defined by structure that protrudes inside the lower portion of the lid to provide the elevated platform.

12. A container lid, comprising:
an upper body with a top surface and a first sidewall extending down from the top surface, the sidewall having outer dimensions;
a built-in scale mounted in the upper body, the scale including a weighing platform, a display and controls disposed on the top surface of the upper body;
a lower body with a bottom surface and a second sidewall extending up from the bottom surface, the second sidewall having relatively smaller outer dimensions than the first sidewall and being surrounded by a seal ring adapted to fit snugly inside a container opening to provide an air-tight seal.

13. The apparatus of claim 12, wherein the bottom surface is provided with a recessed compartment sized to receive a humidity stabilizer.

14. The apparatus of claim 13, further comprising an access cover removably attached
to the bottom surface to cover the recessed compartment, the access cover being provided with one or more openings to allow airflow through the recessed compartment when the cover is attached.

15. The apparatus claim 12, further comprising a protective cover for the top surface
adapted to selectively cover and protect one or more of the weighing platform, display and controls.

15. The apparatus of claim 15, wherein the protective cover is attached to the upper body with a hinge that allows the protective cover to be selectively flipped open and flipped closed by a user.

17. The apparatus of claim 15, further comprising a weighing tray detachably mounted inside a cavity within the protective cover.

18. A container lid, comprising:
an upper body having a top surface and a sidewall extending down from the top surface,
a lower body adapted to selectively engage with and close a container opening for accessing an interior chamber of a storage container,
a built-in scale mounted in the upper body with a weighing platform, a display and controls disposed on the top surface of the upper body, and
a protective cover for the top surface of the upper body adapted to selectively cover and protect one or more of the weighing platform, display and controls.

19. The apparatus of claim 18, wherein the protective cover is attached to the upper body with a hinge that allows the protective cover to be selectively flipped open and flipped closed by a user.

20. The apparatus of claim 18, further comprising a weighing tray detachably mounted inside a cavity within the protective cover.

21. The apparatus of claim 18, wherein the lower body has a bottom surface provided with a recessed compartment sized to receive a humidity stabilizer.
